(19) United States
(12) Patent Application Publication
(10) Pub. No.: US 2023/0032236 A1
(43) Pub. Date: Feb. 2, 2023

(54) DATA STREAMING ACCELERATOR

(71) Applicant: Intel Corporation, Santa Clara, CA (US)

(72) Inventors: Rajesh M. Sankaran, Portland, OR (US); Philip R. Lantz, Cornelius, OR (US); Narayan Ranganathan, Bangalore (IN); Saurabh Gayen, Portland, OR (US); Sanjay Kumar, Hillsboro, OR (US); Nikhil Rao, Bengaluru (IN); Dhananjay A. Joshi, Portland, OR (US); Hai Ming Khor, Hillsboro, OR (US); Utkarsh Y. Kakaiya, Folsom, CA (US)

(73) Assignee: Intel Corporation, Santa Clara, CA (US)

(21) Appl. No.: 17/875,198

(22) Filed: Jul. 27, 2022

Related U.S. Application Data
(60) Provisional application No. 63/226,159, filed on Jul. 27, 2021.

(51) Int. Cl. G06F 3/06

(52) U.S. Cl. CPC G06F 3/061; G06F 3/0638; G06F 3/0679

(57) ABSTRACT

Methods and apparatus relating to data streaming accelerators are described. In an embodiment, a hardware accelerator such as a Data Streaming Accelerator (DSA) logic circuitry provides high-performance data movement and/or data transformation for data to be transferred between a processor (having one or more processor cores) and a storage device. Other embodiments are also disclosed and claimed.

### RELATED APPLICATION

The present application relates to and claims priority from U.S. Provisional Pat. Application, Serial No. 63/226,159, filed Jul. 27, 2021, entitled "DATA STREAMING ACCELERATOR," which is incorporated herein in its entirety and for all purposes.

### FIELD

The present disclosure generally relates to the field of data streaming. More particularly, an embodiment relates to a data streaming accelerator.

### BACKGROUND

Generally, memory used to store data in a computing system can be volatile (to store volatile information) or non-volatile (to store persistent information). Volatile data structures stored in volatile memory are generally used for temporary or intermediate information that is required to support the functionality of a program during the run-time of that program. On the other hand, persistent data structures stored in non-volatile (or persistent memory) are available beyond the run-time of a program and can be reused. Moreover, new data is typically generated as volatile data first, before a user or programmer decides to make the data persistent. For example, programmers or users may cause mapping (i.e., instantiating) of volatile structures in volatile main memory that is directly accessible by a processor. Persistent data structures, on the other hand, are instantiated on non-volatile storage devices like rotating disks attached to Input/Output (I/O or IO) buses or non-volatile memory based devices like a solid state drive.

As computing capabilities are enhanced in processors, one concern or bottleneck is the speed at which memory may be accessed by a processor. For example, to process data, a processor may need to first fetch data from a memory device. After completion of the data processing, the results may need to be stored in the memory device. Therefore, the memory access speed and/or efficiency can have a direct impact on overall system performance.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1A illustrates a Data Streaming Accelerator (DSA) device, according to an embodiment.

FIGS. 1B and 1C illustrate sample fields in a restricted inter-domain memory operation descriptor and an unrestricted inter-domain memory operation descriptor, respectively, according to some embodiments.

FIG. 1D illustrates a flow diagram of a method to provide inter-domain memory operations, according to an embodiment.

FIG. 2A is a block diagram illustrating an exemplary instruction format according to embodiments.

FIG. 2B is a block diagram illustrating the fields of the instruction format that make up the full opcode field according to one embodiment.

FIG. 2C is a block diagram illustrating the fields of the instruction format that make up the register index field according to one embodiment.

FIG. 2D is a block diagram illustrating the fields of the instruction format that make up the augmentation operation field according to one embodiment.

FIG. 3 is a block diagram of a register architecture according to one embodiment.

FIG. 4A is a block diagram illustrating both an exemplary in-order pipeline and an exemplary register renaming, out-of-order issue/execution pipeline according to embodiments.

FIG. 4B is a block diagram illustrating both an exemplary embodiment of an in-order architecture core and an exemplary register renaming, out-of-order issue/execution architecture core to be included in a processor according to embodiments.

FIG. 5 illustrates a block diagram of an SOC (System On Chip) package in accordance with an embodiment.

FIG. 6 is a block diagram of a processing system, according to an embodiment.

FIG. 7 is a block diagram of an embodiment of a processor having one or more processor cores, according to some embodiments.

FIG. 8 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits ("hardware"), computer-readable instructions organized into one or more programs ("software"), or some combination of hardware and software. For the purposes of this disclosure reference to "logic" shall mean either hardware (such as logic circuitry or more generally circuitry or circuit), software, firmware, or some combination thereof.

As mentioned above, as computing capabilities are enhanced in processors, one concern or bottleneck is the speed at which memory may be accessed by a processor. Therefore, the memory access speed and/or efficiency can have a direct impact on overall system performance.

Some embodiments relate to a data streaming accelerator. In one embodiment, a data streaming accelerator provides high-performance data copy and/or transformation acceleration. The logic circuitry of the Data Streaming Accelerator (DSA) may be implemented in a processor Central Processing Unit (CPU), a Graphics Processing Unit (GPU), Graphics Processing Unit (GPU), Field-Programmable Gate Array (FPGA), etc. Further, the DSA logic may optimize streaming data movement and/or transformation operations, e.g., common with applications for high-performance storage, networking, persistent memory, and/or various data processing applications.

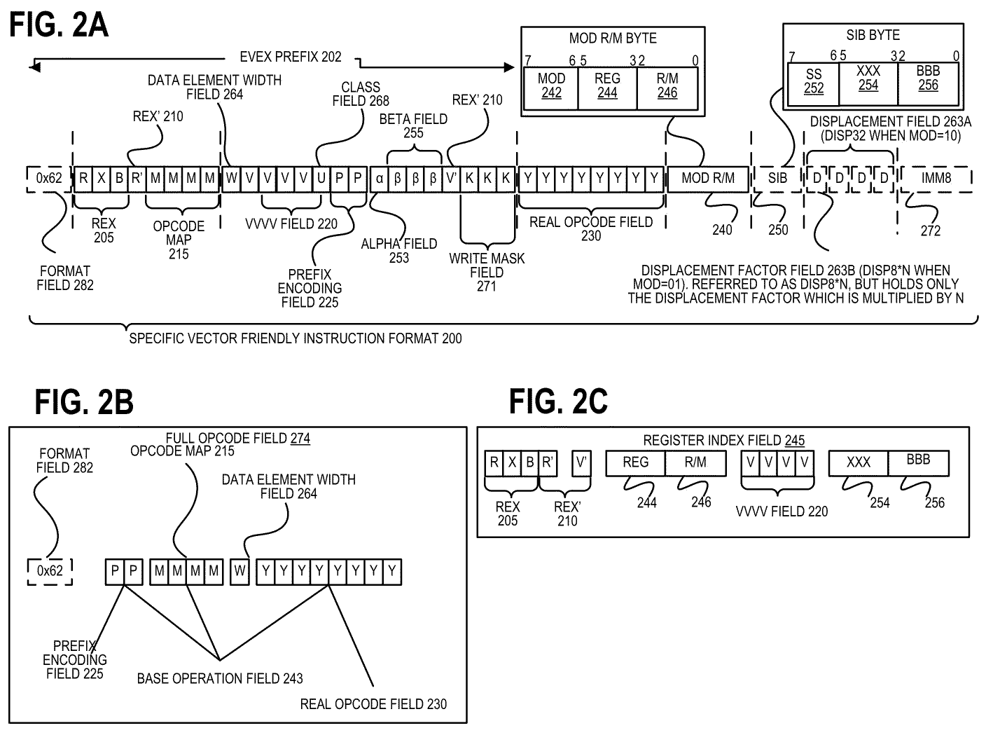

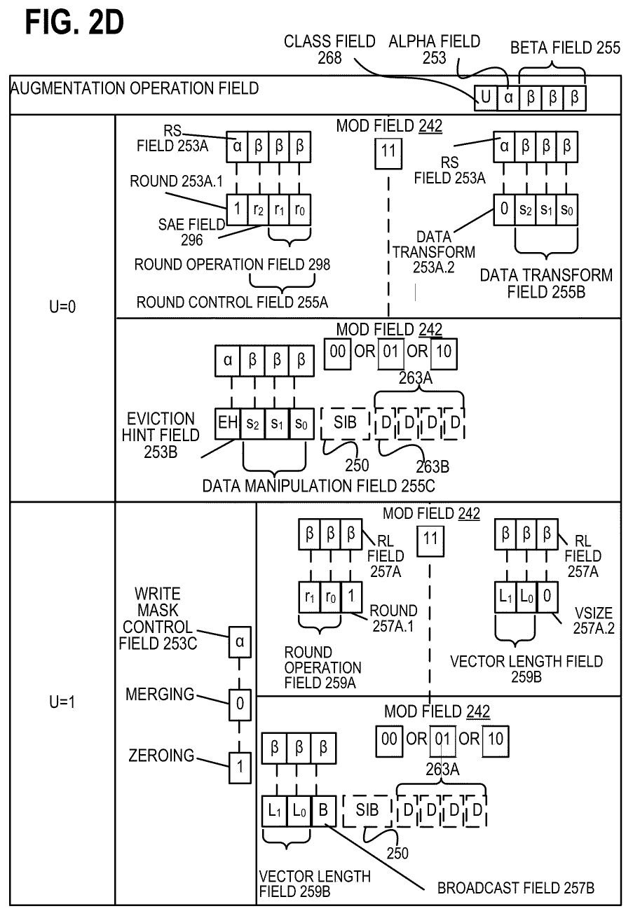

In one or more embodiments, DSA logic can provide improved virtualization efficiency enabling sharing and/or virtualization of devices. In at least some embodiments, one or more of the instructions discussed herein may follow the EVEX format (such as discussed with reference to FIGS. 2A-2D).

Moreover, DSA logic may provide higher overall system performance for data mover and/or transformation operations, while freeing up CPU/processor cycles for other tasks, such as higher level functions. For example, DSA hardware may support high-performance data mover capability to/from volatile memory, persistent memory, Memory Mapped Input/Output (MMIO), and through a Non-Transparent Bridge (NTB) in a System on Chip (SoC) to/from remote volatile and/or persistent memory on another node in a cluster. It may also provide a Peripheral Component Interconnect express (PCIe) compatible programming interface to the Operating System (OS) and/or may be controlled through a device driver.

In addition to performing basic data mover operations, DSA logic may be designed to perform some number of higher-level transformation operations on memory. For example, it may generate and test a Cyclic Redundancy Code (CRC) checksum or Data Integrity Field (DIF) in a memory region to support usages typical with storage and/or networking applications. It may additionally support a memory compare operation for equality, generate a delta record, and/or apply a delta record to a buffer. These may be compared and the delta generate/merge functions may be utilized by applications such as Virtual Machine (VM) migration, VM fast check-pointing, and/or software managed memory deduplication usages.

Further examples of DSA logic features may be found in appendices A and B provided in the U.S. Provisional Pat. Application, Serial No. 63/226,159, filed Jul. 27, 2021, entitled "DATA STREAMING ACCELERATOR," which is incorporated herein in its entirety and for all purposes. However, embodiments are not limited to each and every feature discussed in appendices A and/or B, and DSA implementation may be adjusted for a given design and/or feature set.

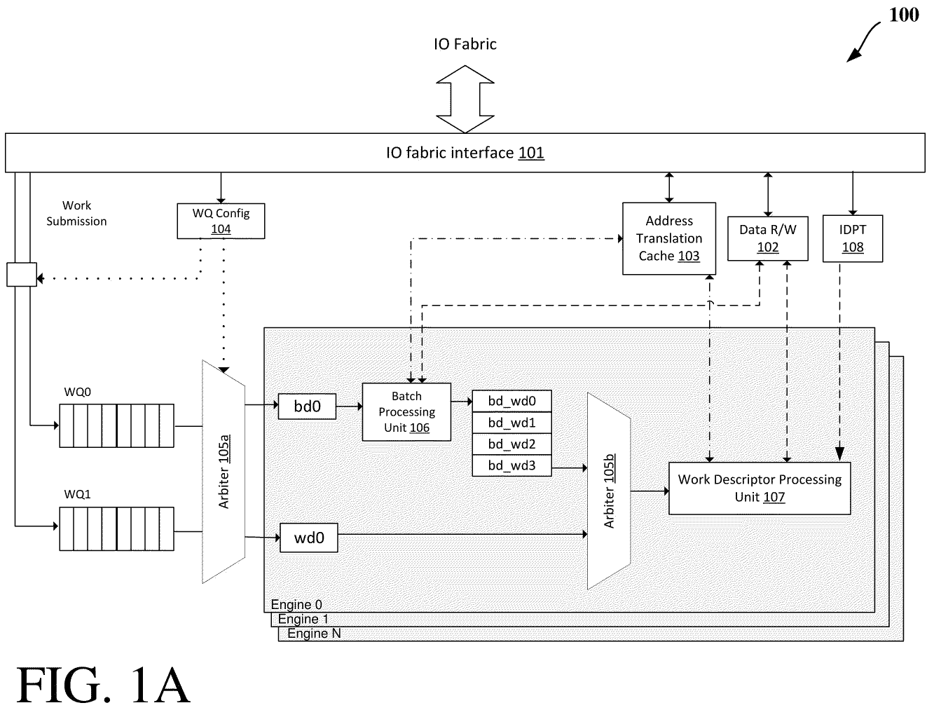

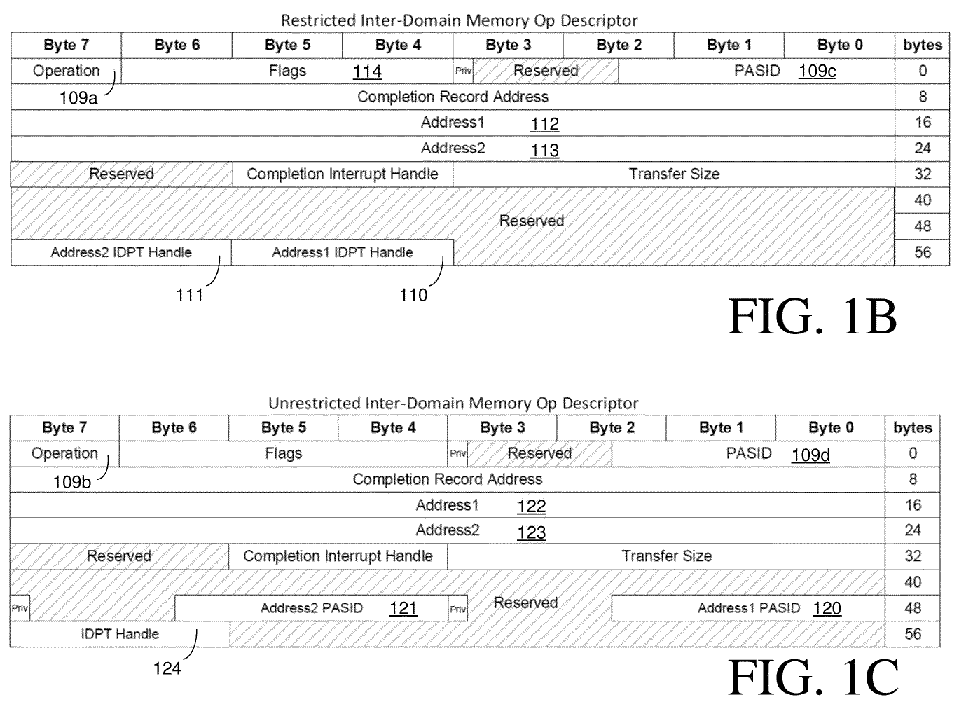

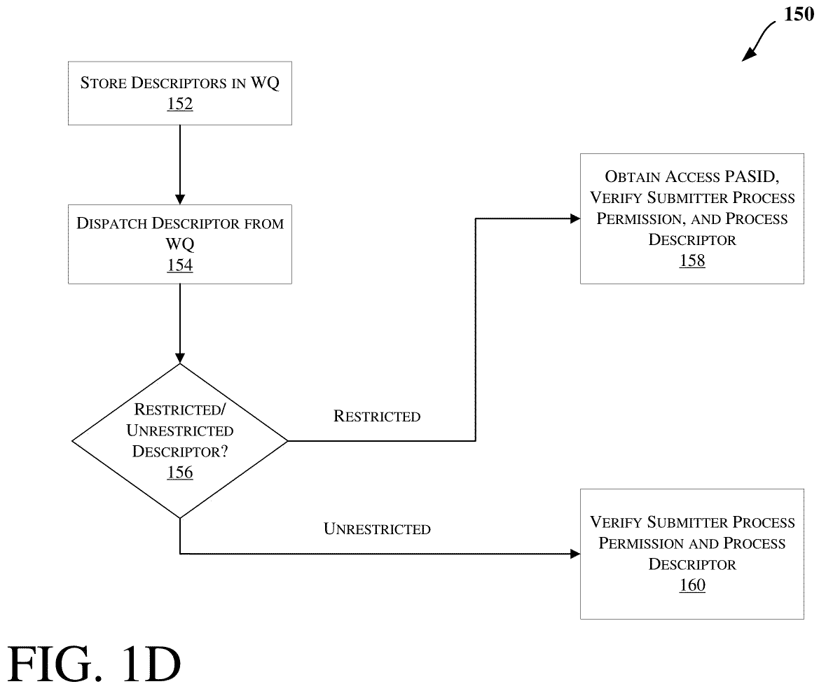

FIG. 1A illustrates a Data Streaming Accelerator (DSA) device 100, according to an embodiment. Downstream work requests from clients are received on the I/O fabric interface 101. Upstream data read/write operations (102) and address translation operations (103) are sent on the I/O fabric interface 101 as well. As shown in FIG. 1A, the device includes one or more Work Queue (WQ) configuration registers 104, Work Queues (labeled as WQO and WQ1) to hold descriptors submitted by software, arbiters 105a/105b used to implement Quality of Service (QoS) and fairness policies, processing engines, address translation logic circuitry and caching interface 103, and a memory read/write interface 102. The batch processing unit 106 processes Batch descriptor(s) (Bd) by reading the array of descriptors from memory. The work descriptor processing unit 107 has stages to read memory, perform the requested operation on the data, generate output data, and write output data, completion records, and interrupt messages.

The WQ configuration logic circuitry 104 allows software to configure each WQ either as a Shared Work Queue (SWQ) that can be shared by multiple software components/applications, or as a Dedicated Work Queue (DWQ) that is assigned to a single software component/application at a time. This configuration also allows software to control which WQs feed into which engines and the relative priorities of the WQs feeding each engine.

In an embodiment, each work descriptor (wd) submitted to the DSA device 100 is associated with a default address space, which corresponds to the address space of the work submitter. While a process address space identifier (PASID) capability is enabled, the default address space is explicitly specified, either by the PASID carried in the work descriptor submitted to a shared work queue, or by the PASID configured in the Work Queue Configuration (WQCFG) register for a dedicated work queue. Memory accesses and Input/Output Memory Management Unit (IOMMU) requests are tagged with this PASID value. While the PASID capability is disabled, the default address space is implicitly specified to the IOMMU via the Peripheral component Interconnect express (PCIe) requester identifier (ID) (bus, device, function) of the device. This address space for a work submitter may be referred to as the descriptor PASID, and this is the address space that descriptors from that submitter normally use for memory accesses and IOMMU requests from the DSA device. While the PASID capability is enabled, certain operations may allow a submitter to select an alternate address space for either the source addresses, destination addresses, or both source and destination addresses specified in a work descriptor. The alternate address space may be that of a cooperating process. This process may be referred to as the owner of that alternate address space. The set of operations that allow selection of an alternate address space may be referred to as inter-domain operations.

In one embodiment, the Inter-Domain operations require the PASID capability to be enabled. Support for inter-domain operations is indicated by the Inter-Domain Support field in a General Capabilities register (GENCAP) register in an embodiment. When this field is 1, inter-domain capabilities are reported in an Inter-Domain Capabilities (IDCAP) register. The set of inter-domain operations supported by an implementation are reported in an Operations Capabilities (OPCAP) register and may be used only if the inter-domain capability is supported. Selection of PASIDs used in each operation may be done using appropriate descriptor fields. Some details of the inter-domain operations supported, along with a description of the corresponding descriptor fields, is discussed below with reference to FIGS. 1B and 1C.

If a work submitter does not explicitly select an alternate PASID for an address in a descriptor, the descriptor PASID is used for memory accesses and IOMMU requests pertaining to that address. If a descriptor selects an alternate PASID for an address, that PASID is used instead of the descriptor PASID, if the submitter has appropriate permissions to do so. When used in this manner, the alternate PASID may be referred to as the access PASID for the corresponding address in a descriptor. The device uses the access PASID to perform memory accesses and IOMMU requests pertaining to that address. The descriptor PASID is used to write the completion record, for interrupt generation, and to verify that a submitter has adequate permissions to the specified access PASID, as described below.

In at least one embodiment, an inter-domain operation may involve two or three PASIDs depending on the use case. Some of the sample use cases are listed below:
1. Data read or write by one or more user-mode submitters from or to a memory region exported by a user-mode owner.
2. Data read or write by a kernel-mode submitter from or to a memory region of a user-mode process.
3. Data read or write by a kernel-mode submitter between memory regions of two distinct user-mode processes.
4. Data read or write by a kernel-mode submitter from or to a memory region of another kernel-mode process.
5. Data read or write by a privileged submitter between memory regions of two distinct guest OSes.
6. Any of the above executed within a guest Operation System (OS).

Use case (1) above requires an owner to explicitly grant access to a portion of its memory space to one or more submitters. The memory region that an owner grants access to is referred to as a memory window. A memory window is only accessible using the owner's PASID as the access PASID. Use cases (2) to (6) involve privileged software accessing memory regions of other user-mode or kernel-mode processes within that OS domain. This may require flexibility and low overhead for a privileged submitter to explicitly specify a PASID for each address in a descriptor, but without compromising security.

Referring to FIG. 1A, if inter-domain operations are supported, DSA implements an Inter-Domain Permissions Table (IDPT) 108 to allow software to manage: (1) the association between a descriptor PASID and an access PASID that a work submitter is allowed to access; (2) attributes of a memory region in an access PASID's memory space that a submitter is allowed to access; and/or (3) controls to manage the life cycle of such association. The IDPT may be managed by the host kernel-mode driver and may be configured to support uses for both kernel-mode and user-mode applications, in a host or guest OS.

FIGS. 1B and 1C illustrate sample fields in a restricted inter-domain memory operation descriptor and an unrestricted inter-domain memory operation descriptor, respectively, according to some embodiments.

In one or more embodiments, each entry in the IDPT contains the following: (1) an entry type as described below; (2) one or more submitter PASID values allowed to use that entry and a mechanism to validate them; (3) depending on the entry type, an access PASID to be used for memory accesses; (4) memory window address range and attributes; and/or (5) permissions and other control information.

Each IDPT Entry (IDPTE) may be configured in one of the following ways as indicated by the Type field described below and summarized in Table 1:
Type 0 - Single Access, Single Submitter (SASS): The IDPTE specifies a single access PASID and a single submitter PASID. For example, a process that wants to expose a memory window to a peer process may request the driver to set up an SASS entry with its own PASID as the access PASID and the PASID of its peer as the submitter PASID.
Type 1 - Single Access, Multiple Submitter (SAMS): The IDPTE specifies a single access PASID. The submitter PASID field in the entry is unused. Instead, the IDPTE points to a bitmap in memory which specifies the set of submitter PASIDs allowed to use the entry. A bit set to 1 in the bitmap indicates that the corresponding PASID is allowed to submit an inter-domain operation using the IDPTE. For example, a process that wants to allow multiple submitters to access a window in its address space requests a SAMS entry to be set up.
Type 2 - Any Access, Single Submitter (AASS): The IDPTE specifies a single submitter PASID. The access PASID is specified in the descriptor. The access PASID may be any PASID in the submitter's domain. For example, a privileged submitter that needs to access memory in multiple user-mode processes can set up an AASS entry.

Table 1

Inter-Domain Permissions Table Entry Types

| Type | Mnemonic | Description | Access PASID obtained from | Submitter PASID matched against |
|---|---|---|---|---|
| 00 | SASS | Single Access, Single-submitter entry (1 access PASID, 1 submitter PASID) | IDPT entry | IDPT entry |
| 01 | SAMS | Single Access, Multi-submitter entry (1 access PASID, N submitter PASIDs) | IDPT entry | Bitmap |
| 10 | AASS | Any-Access, Single-submitter entry (any access PASID, 1 submitter PASID) | Descriptor (no access PASID checking) | IDPT entry |

As discussed herein, a "descriptor" generally refers to an IDPTE entry using a handle in the descriptor. If the Request IDPT Handle field in Command Capabilities (CMDCAP) is 0, the handle is the index of the desired entry in the IDPT. If the Request IDPT Handle field in CMDCAP register is 1, software uses the Request IDPT Handle command to obtain the handle to use. Software specifies in the Request IDPT Handle command the index of the PASID table entry for which it wants a handle, and the response to the command contains the handle that software should place in the descriptor.

In some embodiments, an inter-domain descriptor may contain more than one handle, depending on the type of operation. A separate handle may be specified for each distinct source and/or destination address in a descriptor. Each handle in a descriptor is used by hardware to look up the corresponding IDPTE to: (1) validate access permissions for the submitter, (2) identify the access PASID and privilege to be used for memory access, (3) compute the effective memory address, and/or (4) verify that the access conforms to the memory window and permissions granted by the IDPTE.

In an embodiment, an IDPTE may be referenced by: (a) An inter-domain descriptor while the Usable bit in the IDPTE is 1. In this case, the hardware checks that the descriptor PASID matches a submitter PASID value in the specified IDPTE. (b) An Update Window descriptor while the Allow Update bit in the IDPTE is 1. In this case, the hardware checks that the descriptor PASID matches the access PASID value in the specified IDPTE.

If the PASID values do not match, then memory accesses using that entry are disallowed for that descriptor, and the descriptor is completed with an error.

Furthermore, type 0 SASS and type 1 SAMS IDPTEs may only be used with Restricted Inter-Domain operations (see, e.g., FIG. 1B). A type 2 AASS IDPTE may only be used with Unrestricted Inter-Domain operations (see, e.g., FIG. 1C).

FIGS. 1B and 1C illustrate details of the descriptors for the Inter-Domain operations in accordance with some embodiments. In some embodiments, one or more of the following new operations support Inter-Domain capabilities:
(1) Restricted Inter-Domain Operations: Restricted Inter-Domain Memory Copy (to copy data from the source address to the destination address), Restricted Inter-Domain Fill (to fill memory at the destination address with the value in the pattern field), Restricted Inter-Domain Compare (to compare data at source 1 address with memory at source 2 address), Restricted Inter-Domain Compare Pattern (to compare data at the source address with the value in the pattern field), and/or Restricted Inter-Domain Cache Flush (to flush the processor caches at the destination address).
(2) Unrestricted Inter-Domain Operations: Unrestricted Inter-Domain Memory Copy (to copy data from the source address to the destination address), Unrestricted Inter-Domain Fill (to fill memory at the destination address with the value in the pattern field), Unrestricted Inter-Domain Compare (to compare data at source 1 address with memory at source 2 address), Unrestricted Inter-Domain Compare Pattern (to compare data at the source address with the value in the pattern field), and/or Unrestricted Inter-Domain Cache Flush (to flush the processor caches at the destination address).
(3) Update Window (to atomically modify attributes of the memory window associated with the specified Inter-Domain Permissions Table entry).

Referring to FIG. 1B, a restricted inter-domain descriptor includes an operation field 109a capable of specifying an operation to be performed (such as discussed above, including, for example, copy, fill, compare, compare pattern, flush, etc.), a PASID field 109c capable of specifying a submitter PASID of a submitter process executing on a (e.g., host) processor, and an IDPT handle field 110/111 capable of specifying an IDPT entry.

Referring to FIG. 1C, an unrestricted inter-domain descriptor includes an operation field 109b capable of specifying an operation to be performed (such as discussed above, including, for example, copy, fill, compare, compare pattern, flush, etc.), a PASID field (109d) capable of specifying a submitter PASID of a submitter process to be executed on a processor, an access PASID field 120/121 capable of specifying an access PASID associated with the address space of another process, and an IDPT handle field 124 capable of specifying an IDPT entry.

As shown in FIG. 1B, the descriptor for a Restricted Inter-Domain operation allows software to specify an IDPT handle 110/111 for each source or destination address 112/113. The IDPT handle 110/111 references a type 0 SASS or type 1 SAMS IDPTE (described above). There is at least one valid IDPT handle indicated by the corresponding flags bit 114 set to 1.

As shown in FIG. 1C, the descriptor for an Unrestricted Inter-Domain operation allows software to directly specify the access PASID and privilege (Priv) values 120/121 for each source or destination address 122/123. The descriptor also specifies an IDPT handle 124 that references a type 2 AASS IDPTE (described above).

Hence, in some embodiments, access PASIDs are specified in the new descriptor shown in FIG. 1B and/or 1C to allow for access to alternative address spaces. As discussed with reference to FIGS. 1B and 1C, descriptors for restricted and unrestricted inter-domain operations handle these differently.

FIG. 1D illustrates a flow diagram of a method 150 to provide inter-domain memory operations, according to an embodiment. One or more components discussed herein may be utilized to perform the operations of method 130 such as a hardware accelerator (e.g., DSA 100 of FIG. 1A) and/or a processor (such as discussed with reference to FIG. 2A et seq.

Referring to FIGS. 1A-1D, at an operation 152 a plurality of descriptors are stored in a work queue (e.g., WQ0 or WQ1 of FIG. 1A). At an operation 154, an arbiter (e.g., arbiter 105a of FIG. 1A) dispatches a descriptor from the work queue. As discussed with reference to FIGS. 1B and 1C, the descriptor may include: an operation field capable of specifying an operation to be performed, a Process Address Space Identifier (PASID) field capable of specifying a submitter PASID of a submitter process, an Inter-Domain Permissions Table (IDPT) handle field capable of specifying an IDPT entry, and optionally an access PASID field capable of specifying an access PASID associated with the address space of another process.

At an operation 156, it is determined whether the dispatched descriptor from operation 154 is to be treated as a restricted inter-domain memory operation descriptor or an unrestricted inter-domain memory operation descriptor. At an operation 158, for a restricted inter-domain memory operation descriptor, an engine (e.g., one of the engines 0-N of FIG. 1A): (a) obtains an access PASID, associated with an address space of another process, from the IDPT entry; (b) verifies, based at least in part on the submitter PASID and the IDPT entry, whether the submitter process is permitted to access the address space of the other process; and (c) processes (e.g., by the work descriptor processing unit 107 of FIG. 1A) the descriptor based at least in part on the operation specified by the operation field.

At an operation 160, for an unrestricted inter-domain memory operation descriptor, an engine (e.g., one of the engines 0-N of FIG. 1A): (a) verifies, based at least in part on the submitter PASID and the IDPT entry, whether the submitter process is permitted to access an address space of another process; and (b) processes (e.g., by the work descriptor processing unit 107 of FIG. 1A) the descriptor based at least in part on the operation specified by the operation field.

In one or more embodiments, the operation to be performed is one of: a copy operation, a fill operation, a compare operation, a compare pattern operation, and a flush operation.

Moreover, in various embodiments: (a) an IDPT entry may specify a single access PASID and a single submitter PASID; (b) an IDPT entry may specify a single access PASID and a plurality of submitter PASIDs; and/or (c) a plurality of submitter PASIDs may be specified by a PASID bitmap in memory.

Additionally, some embodiments may be applied in computing systems that include one or more processors (e.g., where the one or more processors may include one or more processor cores), such as those discussed with reference to FIG. 1A et seq., including for example a desktop computer, a work station, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Instruction Sets

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

While embodiments will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

FIG. 2A is a block diagram illustrating an exemplary instruction format according to embodiments. FIG. 2A shows an instruction format 200 that is specific in the sense that it specifies the location, size, interpretation, and order of the fields, as well as values for some of those fields. The instruction format 200 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions.

EVEX Prefix (Bytes 0-3) 202 - is encoded in a four-byte form.

Format Field 282 (EVEX Byte 0, bits [7:0]) - the first byte (EVEX Byte 0) is the format field 282 and it contains 0x62 (the unique value used for distinguishing the vector friendly instruction format in one embodiment).

The second-fourth bytes (EVEX Bytes 1-3) include a number of bit fields providing specific capability.

REX field 205 (EVEX Byte 1, bits [7-5]) – consists of a EVEX.R bit field (EVEX Byte 1, bit [7] – R), EVEX.X bit field (EVEX byte 1, bit [6] – X), and 257BEX byte 1, bit[5] – B). The EVEX.R, EVEX.X, and EVEX.B bit fields provide the same functionality as the corresponding VEX bit fields, and are encoded using 1 s complement form, i.e., ZMMO is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX' field QAc10 - this is the EVEX.R' bit field (EVEX Byte 1, bit [4] - R') that is used to encode either the upper 16 or lower 16 of the extended 32 register set. In one embodiment, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments do not store this and the other indicated bits below in the inverted format. A value of 1 is used to encode the lower 16 registers. In other words, R'Rrrr is formed by combining EVEX.R', EVEX.R, and the other RRR from other fields.

Opcode map field 215 (EVEX byte 1, bits [3:0] – mmmm) - its content encodes an implied leading opcode byte (0F, 0F 38, or 0F 3).

Data element width field 264 (EVEX byte 2, bit [7] – W) - is represented by the notation EVEX.W. EVEX.W is used to define the granularity (size) of the datatype (either 32-bit data elements or 64-bit data elements). This field is optional in the sense that it is not needed if only one data element width is supported and/or data element widths are supported using some aspect of the opcodes.

EVEX.vvvv 220 (EVEX Byte 2, bits [6:3]-vvvv)- the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 220 encodes the 4 low-order bits of the first source register specifier stored in inverted (1s complement) form. Depending on the instruction, an extra different EVEX bit field is used to extend the specifier size to 32 registers.

EVEX.U 268 Class field (EVEX byte 2, bit [2]-U) - If EVEX.U = 0, it indicates class A (support merging-writemasking) or EVEX.UO; if EVEX.U = 1, it indicates class B (support zeroing and merging-writemasking)or EVEX.U1.

Prefix encoding field 225 (EVEX byte 2, bits [1:0]-pp) - provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 253 (EVEX byte 3, bit [7] - EH; also known as EVEX.EH, EVEX.rs, EVEX.RL, EVEX.writemask control, and EVEX.N; also illustrated with α) -its content distinguishes which one of the different augmentation operation types are to be performed.

Beta field 255 (EVEX byte 3, bits [6:4]-SSS, also known as EVEX.s2-0, EVEX.r2-0, EVEX.rr1, EVEX.LL0, EVEX.LLB; also illustrated with βββ) -distinguishes which of the operations of a specified type are to be performed.

REX’ field 210 - this is the remainder of the REX’ field and is the EVEX.V’ bit field (EVEX Byte 3, bit [3] - V’) that may be used to encode either the upper 16 or lower 16 of the extended 32 register set. This bit is stored in bit inverted format. A value of 1 is used to encode the lower 16 registers. In other words, V’VVVV is formed by combining EVEX.V’, EVEX.vvvv.

Writemask field 271 (EVEX byte 3, bits [2:0]-kkk) - its content specifies the index of a register in the writemask registers. In one embodiment, the specific value EVEX.kkk=000 has a special behavior implying no writemask is used for the particular instruction (this may be implemented in a variety of ways including the use of a writemask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the writemask field 271 allows for partial vector operations, including loads, stores, arithmetic, logical, etc. While embodiments are described in which the writemask field’s 271 content selects one of a number of writemask registers that contains the writemask to be used (and thus the writemask field’s 271 content indirectly identifies that masking to be performed), alternative embodiments instead or additional allow the mask write field’s 271 content to directly specify the masking to be performed.

Real Opcode Field 230 (Byte 4) is also known as the opcode byte. Part of the opcode is specified in this field.

MOD R/M Field 240 (Byte 5) includes MOD field 242, register index field 244, and R/M field 246. The MOD field’s 242 content distinguishes between memory access and non-memory access operations. The role of register index field 244 can be summarized to two situations: encoding either the destination register operand or a source register operand, or be treated as an opcode extension and not used to encode any instruction operand. The content of register index field 244, directly or through address generation, specifies the locations of the source and destination operands, be they in registers or in memory. These include a sufficient number of bits to select N registers from a PxQ (e.g., 32x512, 16x128, 32x1024, 64x1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

The role of R/M field 246 may include the following: encoding the instruction operand that references a memory address, or encoding either the destination register operand or a source register operand.

Scale, Index, Base (SIB) Byte (Byte 6) - The scale field’s 250 content allows for the scaling of the index field’s content for memory address generation (e.g., for address generation that uses 2scale * index + base). SIB.xxx 254 and SIB.bbb 256 – the contents of these fields have been previously referred to with regard to the register indexes Xxxx and Bbbb.

Displacement field 263A (Bytes 7-10) - when MOD field 242 contains 10, bytes 7-10 are the displacement field 263A, and it works the same as the legacy 32-bit displacement (disp32) and works at byte granularity. This may be used as part of memory address generation (e.g., for address generation that uses 2scale * index + base + displacement).

Displacement factor field 263B (Byte 7) - when MOD field 242 contains 01, byte 7 is the displacement factor field 263B. The location of this field is that same as that of the legacy x86 instruction set 8-bit displacement (disp8), which works at byte granularity. Since disp8 is sign extended, it can only address between -128 and 127 bytes offsets; in terms of 64 byte cache lines, disp8 uses 8 bits that can be set to only four really useful values -128, -64, 0, and 64; since a greater range is often needed, disp32 is used; however, disp32 requires 4 bytes. In contrast to disp8 and disp32, the displacement factor field 263B is a reinterpretation of disp8; when using displacement factor field 263B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 263B substitutes the legacy x86 instruction set 8-bit displacement. Thus, the displacement factor field 263B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate field 272 allows for the specification of an immediate. This field is optional in the sense that is it not present in an implementation of the generic vector friendly format that does not support immediate and it is not present in instructions that do not use an immediate.

### Full Opcode Field

FIG. 2B is a block diagram illustrating the fields of the instruction format 200 that make up the full opcode field 274 according to one embodiment. Specifically, the full opcode field 274 includes the format field 282, the base operation field 243, and the data element width (W) field 263. The base operation field 243 includes the prefix encoding field 225, the opcode map field 215, and the real opcode field 230.

### Register Index Field

FIG. 2C is a block diagram illustrating the fields of the format 200 that make up the register index field 245 according to one embodiment. Specifically, the register index field 245 includes the REX field 205, the REX’ field 210, the MODR/M.reg field 244, the MODR/M.r/m field 246, the VVVV field 220, xxx field 254, and the bbb field 256.

### Augmentation Operation Field

FIG. 2D is a block diagram illustrating the fields of the instruction format 200 that make up an augmentation operation field according to one embodiment. When the class (U) field 268 contains 0, it signifies EVEX.U0 (class A 268A); when it contains 1, it signifies EVEX.U1 (class B 268B). When U=0 and the MOD field 242 contains 11 (signifying a no memory access operation), the alpha field 253 (EVEX byte 3, bit [7] -EH) is interpreted as the rs field 253A. When the rs field 253A contains a 1 (round 253A.1), the beta field 255 (EVEX byte 3, bits [6:4]- SSS) is interpreted as the round control field 255A. The round control field 255A includes a one bit SAE field 296 and a two bit round operation field 298. When the rs field 253A contains a 0 (data transform 253A.2), the beta field 255 (EVEX byte 3, bits [6:4]- SSS) is interpreted as a three bit data transform field 255B. When U=0 and the MOD field 242 contains 00, 01, or 10 (signifying a memory access operation), the alpha field 253 (EVEX byte 3, bit [7] - EH) is interpreted as the eviction hint (EH) field 253B and the beta field 255 (EVEX byte 3, bits [6:4]- SSS) is interpreted as a three bit data manipulation field 255C.

When U=1, the alpha field 253 (EVEX byte 3, bit [7] - EH) is interpreted as the writemask control (Z) field 253C. When U=1 and the MOD field 242 contains 11 (signifying a no memory access operation), part of the beta field 255 (EVEX byte 3, bit [4]- S0) is interpreted as the RL field 257A; when it contains a 1 (round 257A.1) the rest of the beta field 255 (EVEX byte 3, bit [6-5]- S2-1) is interpreted as the round operation field 259A, while when the RL field 257A contains a 0 (VSIZE 257.A2) the rest of the beta field 255 (EVEX byte 3, bit [6-5]- S2-1) is interpreted as the vector length field 259B (EVEX byte 3, bit [6-5]- L1-0). When U=1 and the MOD field 242 contains 00, 01, or 10 (signifying a memory access operation), the beta field 255 (EVEX byte 3, bits [6:4]- SSS) is interpreted as the vector length field 259B (EVEX byte 3, bit [6-5]- L1-0) and the broadcast field 257B (EVEX byte 3, bit [4]- B).

### Exemplary Register Architecture

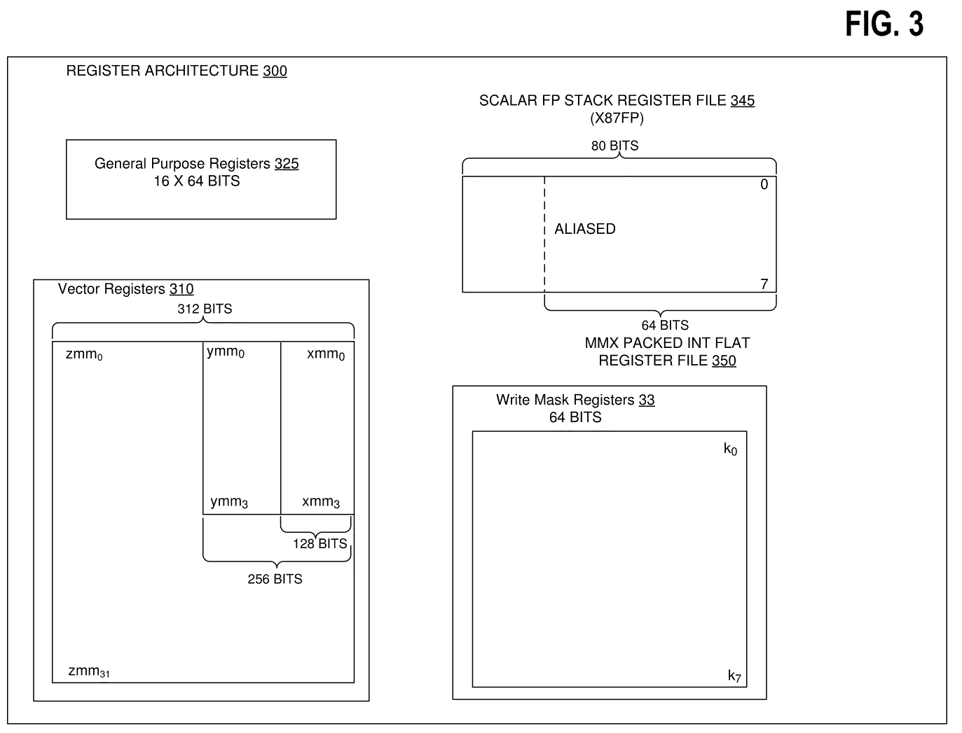

FIG. 3 is a block diagram of a register architecture 300 according to one embodiment. In the embodiment illustrated, there are 32 vector registers 310 that are 312 bits wide; these registers are referenced as ZMM0 through ZMM31. The lower order 256 bits of the lower 16 ZMM registers are overlaid on registers YMM0-16. The lower order 128 bits of the lower 16 ZMM registers (the lower order 128 bits of the YMM registers) are overlaid on registers XMM0-15. In other words, the vector length field 459B selects between a maximum length and one or more other shorter lengths, where each such shorter length is half the length of the preceding length; and instructions templates without the vector length field 459B operate on the maximum vector length. Further, in one embodiment, the class B instruction templates of the instruction format 400 operate on packed or scalar single/double-precision floating point data and packed or scalar integer data. Scalar operations are operations performed on the lowest order data element position in a ZMM/YMM/XMM register; the higher order data element positions are either left the same as they were prior to the instruction or zeroed depending on the embodiment.

Writemask registers 315 - in the embodiment illustrated, there are 8 writemask registers (k0 through k7), each 64 bits in size. In an alternate embodiment, the writemask registers 315 are 16 bits in size. In some embodiments, the vector mask register k0 cannot be used as a writemask; when the encoding that would normally indicate k0 is used for a writemask, it selects a hardwired writemask of OxFFFF, effectively disabling writemasking for that instruction.

General-purpose registers 325 - in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 345, on which is aliased the MMX packed integer flat register file 350 - in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments may use wider or narrower registers. Additionally, alternative embodiments may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU (Central Processing Unit) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

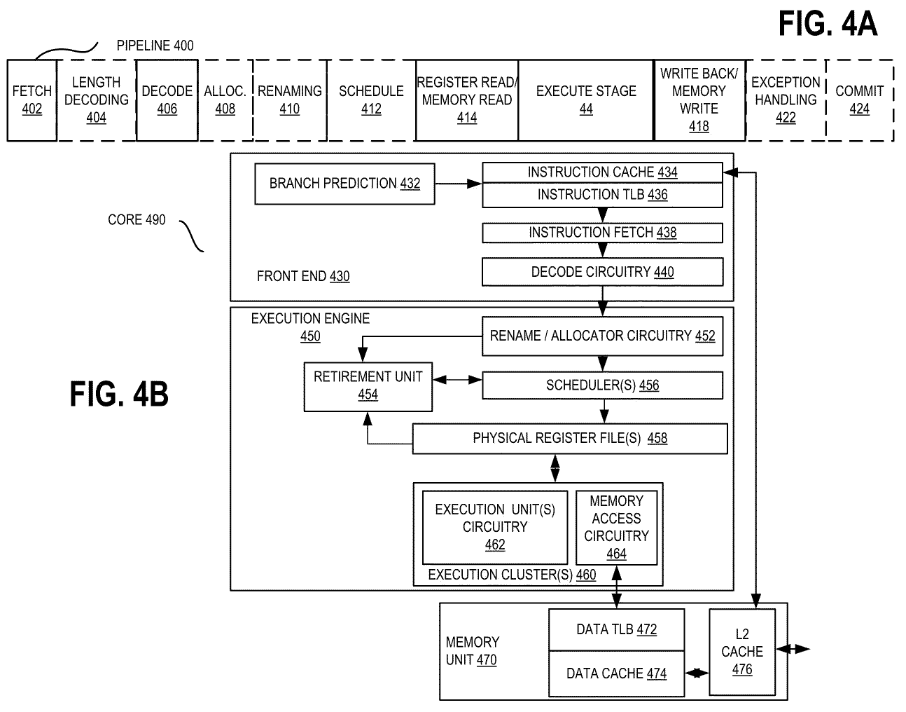

FIG. 4A is a block diagram illustrating both an exemplary in-order pipeline and an exemplary register renaming, out-of-order issue/execution pipeline according to embodiments. FIG. 4B is a block diagram illustrating both an exemplary embodiment of an in-order architecture core and an exemplary register renaming, out-of-order issue/execution architecture core to be included in a processor according to embodiments. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424.

FIG. 4B shows processor core 490 including a front end unit 430 coupled to an execution engine unit 450, and both are coupled to a memory unit 470. The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, coprocessor core, general purpose computing graphics processing unit (GPGPU) core, graphics core, or the like.

The front end unit 430 includes a branch prediction unit 432 coupled to an instruction cache unit 434, which is coupled to an instruction translation lookaside buffer (TLB) 436, which is coupled to an instruction fetch unit 438, which is coupled to a decode unit 440. The decode unit 440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 490 includes a microcode ROM or other medium that stores microcode for certain macroinstructions (e.g., in decode unit 440 or otherwise within the front end unit 430). The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The scheduler unit(s) 456 represents any number of different schedulers, including reservations stations, central instruction window, etc. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point,, status (e.g., an instruction pointer that is the address of the next instruction to be executed), etc. In one embodiment, the physical register file(s) unit 458 comprises a vector registers unit, a writemask registers unit, and a scalar registers unit. These register units may provide architectural vector registers, vector mask registers, and general purpose registers. The physical register file(s) unit(s) 458 is overlapped by the retirement unit 454 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 454 and the physical register file(s) unit(s) 458 are coupled to the execution cluster(s) 460. The execution cluster(s) 460 includes a set of one or more execution units 462 and a set of one or more memory access units 464. The execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster - and in the case of a separate memory access pipeline, certain embodiments are implemented in which only the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which includes a data TLB unit 472 coupled to a data cache unit 474 coupled to a level 2 (L2) cache unit 476. In one exemplary embodiment, the memory access units 464 may include a load unit, a store address unit, and a store data unit, each of which is coupled to the data TLB unit 472 in the memory unit 470. The instruction cache unit 434 is further coupled to a level 2 (L2) cache unit 476 in the memory unit 470. The L2 cache unit 476 is coupled to one or more other levels of cache and eventually to a main memory.

By way of example, the exemplary register renaming, out-of-order issue/execution core architecture may implement the pipeline 400 as follows: 1) the instruction fetch 438 performs the fetch and length decoding stages 402 and 404; 2) the decode unit 440 performs the decode stage 406; 3) the rename/allocator unit 452 performs the allocation stage 408 and renaming stage 410; 4) the scheduler unit(s) 456 performs the schedule stage 412; 5) the physical register file(s) unit(s) 458 and the memory unit 470 perform the register read/memory read stage 414; the execution cluster 460 perform the execute stage 416; 6) the memory unit 470 and the physical register file(s) unit(s) 458 perform the write back/memory write stage 418; 7) various units may be involved in the exception handling stage 422; and 8) the retirement unit 454 and the physical register file(s) unit(s) 458 perform the commit stage 424.

The core 490 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 490 includes logic to support a packed data instruction set extension (e.g., AVX1, AVX2), thereby allowing the operations used by many multimedia applications to be performed using packed data.

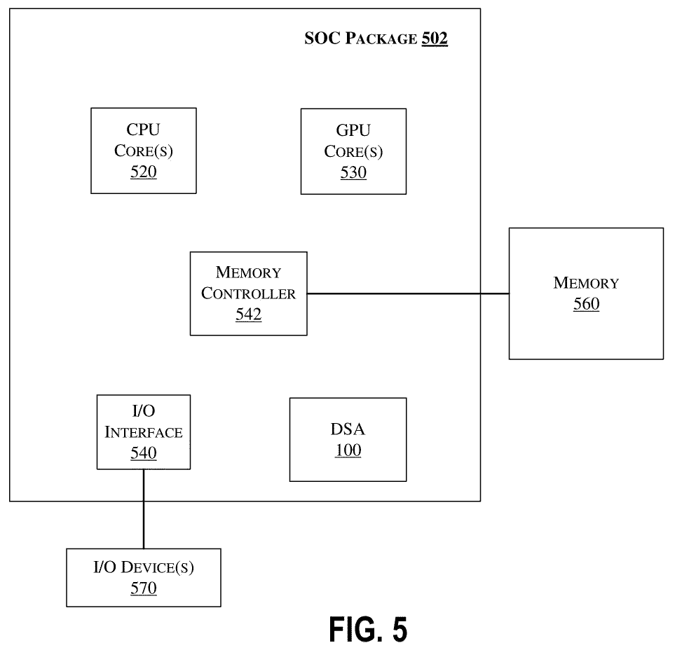

FIG. 5 illustrates a block diagram of an SOC package in accordance with an embodiment. As illustrated in FIG. 5, SOC 502 includes one or more Central Processing Unit (CPU) cores 520, one or more Graphics Processor Unit (GPU) cores 530, an Input/Output (I/O) interface 540, and a memory controller 542. Various components of the SOC package 502 may be coupled to an interconnect or bus such as discussed herein with reference to the other figures. Also, the SOC package 502 may include more or less components, such as those discussed herein with reference to the other figures. Further, each component of the SOC package 502 may include one or more other components, e.g., as discussed with reference to the other figures herein. In one embodiment, SOC package 502 (and its components) is provided on one or more Integrated Circuit (IC) die, e.g., which are packaged into a single semiconductor device.

As illustrated in FIG. 5, SOC package 502 is coupled to a memory 560 via the memory controller 542. In an embodiment, the memory 560 (or a portion of it) can be integrated on the SOC package 502.

The I/O interface 540 may be coupled to one or more I/O devices 570, e.g., via an interconnect and/or bus such as discussed herein with reference to other figures. I/O device(s) 570 may include one or more of a keyboard, a mouse, a touchpad, a display, an image/video capture device (such as a camera or camcorder/video recorder), a touch screen, a speaker, or the like.

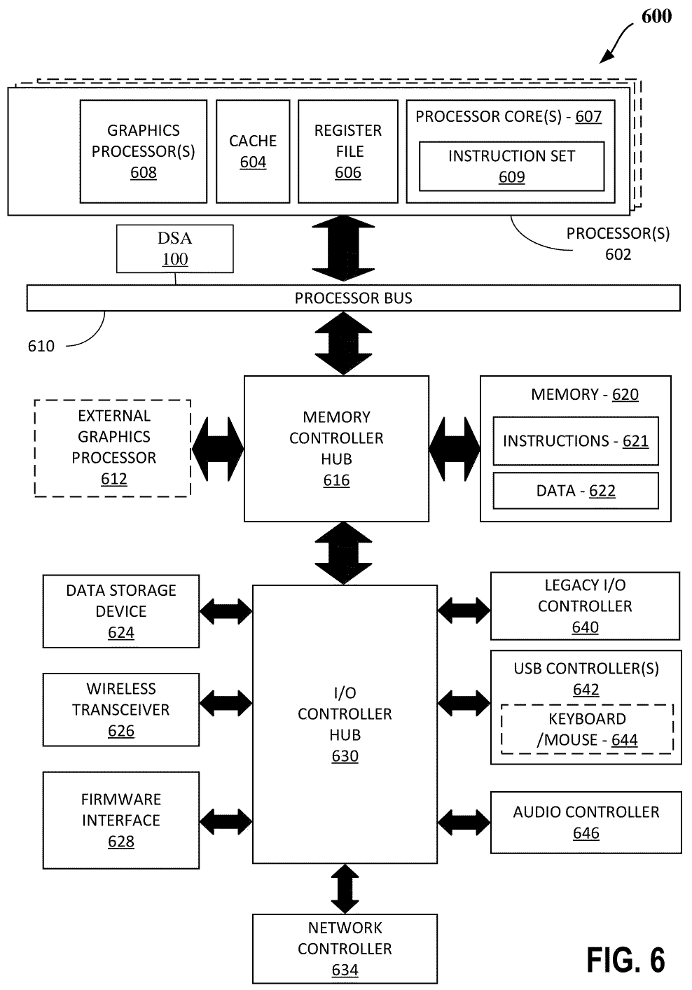

FIG. 6 is a block diagram of a processing system 600, according to an embodiment. In various embodiments the system 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC or SOC) integrated circuit for use in mobile, handheld, or embedded devices.

An embodiment of system 600 can include, or be incorporated within a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 609. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 602 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, processor 602 is coupled to a processor bus 610 to transmit communication signals such as address, data, or control signals between processor 602 and other components in system 600. In one embodiment the system 600 uses an exemplary ‘hub’ system architecture, including a memory controller hub 616 and an Input Output (I/O) controller hub 630. A memory controller hub 616 facilitates communication between a memory device and other components of system 600, while an I/O Controller Hub (ICH) 630 provides connections to I/O devices via a local I/O bus. In one embodiment, the logic of the memory controller hub 616 is integrated within the processor.

Memory device 620 can be a dynamic random access memory (DRAM) device, a static random access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 executes an application or process. Memory controller hub 616 also couples with an optional external graphics processor 612, which may communicate with the one or more graphics processors 608 in processors 602 to perform graphics and media operations.

In some embodiments, ICH 630 enables peripherals to connect to memory device 620 and processor 602 via a high-speed I/O bus. The I/O peripherals include, but are not limited to, an audio controller 646, a firmware interface 628, a wireless transceiver 626 (e.g., Wi-Fi, Bluetooth), a data storage device 624 (e.g., hard disk drive, flash memory, etc.), and a legacy I/O controller 640 for coupling legacy (e.g., Personal System 2 (PS/2)) devices to the system. One or more Universal Serial Bus (USB) controllers 642 connect input devices, such as keyboard and mouse 644 combinations. A network controller 634 may also couple to ICH 630. In some embodiments, a high-performance network controller (not shown) couples to processor bus 610. It will be appreciated that the system 600 shown is exemplary and not limiting, as other types of data processing systems that are differently configured may also be used. For example, the I/O controller hub 630 may be integrated within the one or more processor 602, or the memory controller hub 616 and I/O controller hub 630 may be integrated into a discreet external graphics processor, such as the external graphics processor 612.

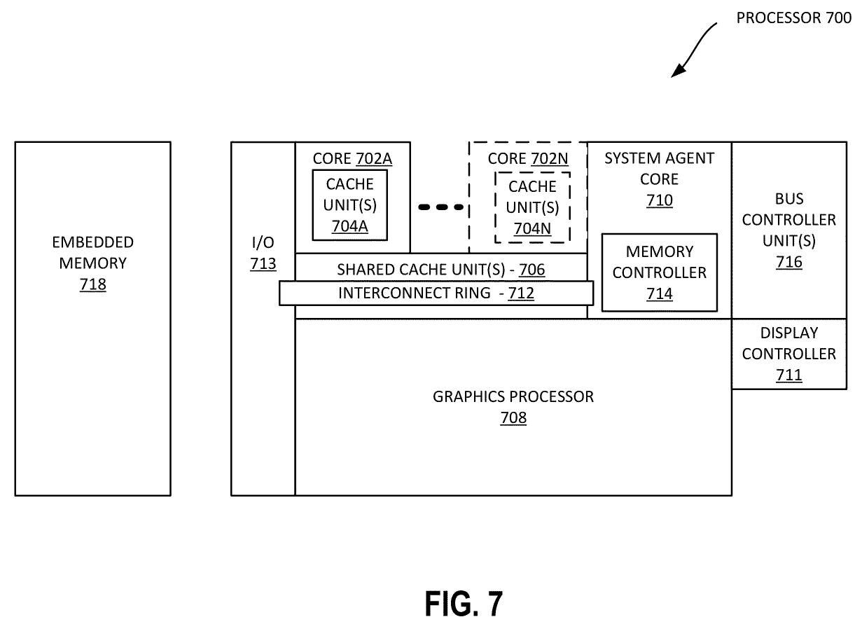

FIG. 7 is a block diagram of an embodiment of a processor 700 having one or more processor cores 702A to 702N, an integrated memory controller 714, and an integrated graphics processor 708. Those elements of FIG. 7 having the same reference numbers (or names) as the elements of any other figure herein can operate or function in any manner similar to that described elsewhere herein, but are not limited to such. Processor 700 can include additional cores up to and including additional core 702N represented by the dashed lined boxes. Each of processor cores 702A to 702N includes one or more internal cache units 704A to 704N. In some embodiments each processor core also has access to one or more shared cached units 706.

The internal cache units 704A to 704N and shared cache units 706 represent a cache memory hierarchy within the processor 700. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 706 and 704A to 704N.

In some embodiments, processor 700 may also include a set of one or more bus controller units 716 and a system agent core 710. The one or more bus controller units 716 manage a set of peripheral buses, such as one or more Peripheral Component Interconnect buses (e.g., PCI, PCI Express). System agent core 710 provides management functionality for the various processor components. In some embodiments, system agent core 710 includes one or more integrated memory controllers 714 to manage access to various external memory devices (not shown).

In some embodiments, one or more of the processor cores 702A to 702N include support for simultaneous multi-threading. In such embodiment, the system agent core 710 includes components for coordinating and operating cores 702A to 702N during multi-threaded processing. System agent core 710 may additionally include a power control unit (PCU), which includes logic and components to regulate the power state of processor cores 702A to 702N and graphics processor 708.

In some embodiments, processor 700 additionally includes graphics processor 708 to execute graphics processing operations. In some embodiments, the graphics processor 708 couples with the set of shared cache units 706, and the system agent core 710, including the one or more integrated memory controllers 714. In some embodiments, a display controller 711 is coupled with the graphics processor 708 to drive graphics processor output to one or more coupled displays. In some embodiments, display controller 711 may be a separate module coupled with the graphics processor via at least one interconnect, or may be integrated within the graphics processor 708 or system agent core 710.

In some embodiments, a ring based interconnect unit 712 is used to couple the internal components of the processor 700. However, an alternative interconnect unit may be used, such as a point-to-point interconnect, a switched interconnect, or other techniques, including techniques well known in the art. In some embodiments, graphics processor 708 couples with the ring interconnect 712 via an I/O link 713.

The exemplary I/O link 713 represents at least one of multiple varieties of I/O interconnects, including an on package I/O interconnect which facilitates communication between various processor components and a high-performance embedded memory module 718, such as an eDRAM (or embedded DRAM) module. In some embodiments, each of the processor cores 702 to 702N and graphics processor 708 use embedded memory modules 718 as a shared Last Level Cache.

In some embodiments, processor cores 702A to 702N are homogenous cores executing the same instruction set architecture. In another embodiment, processor cores 702A to 702N are heterogeneous in terms of instruction set architecture (ISA), where one or more of processor cores 702A to 702N execute a first instruction set, while at least one of the other cores executes a subset of the first instruction set or a different instruction set. In one embodiment processor cores 702A to 702N are heterogeneous in terms of micro architecture, where one or more cores having a relatively higher power consumption couple with one or more power cores having a lower power consumption. Additionally, processor 700 can be implemented on one or more chips or as an SoC integrated circuit having the illustrated components, in addition to other components.

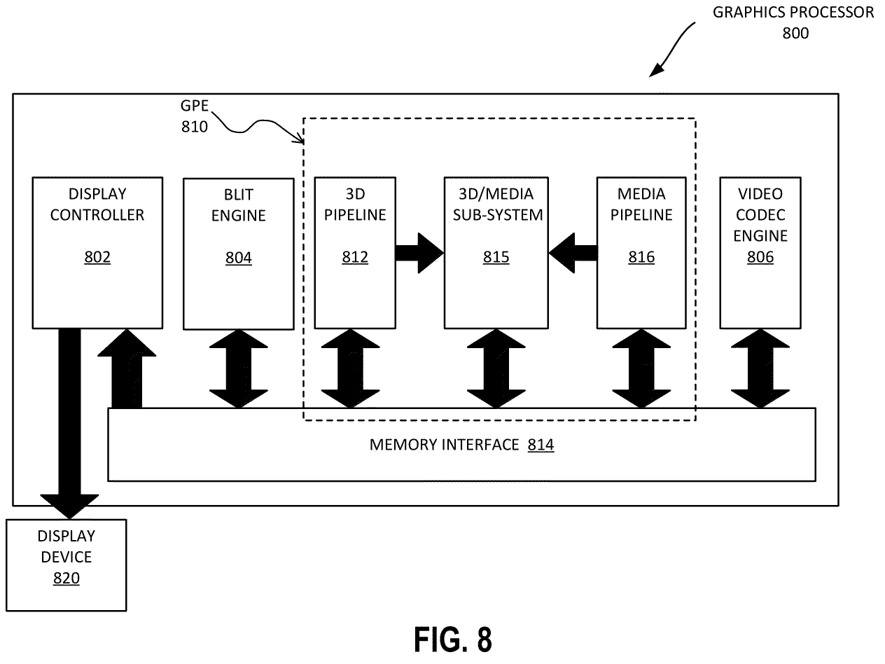

FIG. 8 is a block diagram of a graphics processor 800, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 800 includes a memory interface 814 to access memory. Memory interface 814 can be an interface to local memory, one or more internal caches, one or more shared external caches, and/or to system memory.

In some embodiments, graphics processor 800 also includes a display controller 802 to drive display output data to a display device 820. Display controller 802 includes hardware for one or more overlay planes for the display and composition of multiple layers of video or user interface elements. In some embodiments, graphics processor 800 includes a video codec engine 806 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 800 includes a block image transfer (BLIT) engine 804 to perform two-dimensional (2D) rasterizer operations including, for example, bit-boundary block transfers. However, in one embodiment, 3D graphics operations are performed using one or more components of graphics processing engine (GPE) 810. In some embodiments, graphics processing engine 810 is a compute engine for performing graphics operations, including three-dimensional (3D) graphics operations and media operations.

In some embodiments, GPE 810 includes a 3D pipeline 812 for performing 3D operations, such as rendering three-dimensional images and scenes using processing functions that act upon 3D primitive shapes (e.g., rectangle, triangle, etc.). The 3D pipeline 812 includes programmable and fixed function elements that perform various tasks within the element and/or spawn execution threads to a 3D/Media sub-system 815. While 3D pipeline 812 can be used to perform media operations, an embodiment of GPE 810 also includes a media pipeline 816 that is specifically used to perform media operations, such as video post-processing and image enhancement.

In some embodiments, media pipeline 816 includes fixed function or programmable logic units to perform one or more specialized media operations, such as video decode acceleration, video de-interlacing, and video encode acceleration in place of, or on behalf of video codec engine 806. In some embodiments, media pipeline 816 additionally includes a thread spawning unit to spawn threads for execution on 3D/Media sub-system 815. The spawned threads perform computations for the media operations on one or more graphics execution units included in 3D/Media sub-system 815.

In some embodiments, 3D/Media subsystem 815 includes logic for executing threads spawned by 3D pipeline 812 and media pipeline 816. In one embodiment, the pipelines send thread execution requests to 3D/Media subsystem 815, which includes thread dispatch logic for arbitrating and dispatching the various requests to available thread execution resources. The execution resources include an array of graphics execution units to process the 3D and media threads. In some embodiments, 3D/Media subsystem 815 includes one or more internal caches for thread instructions and data. In some embodiments, the subsystem also includes shared memory, including registers and addressable memory, to share data between threads and to store output data.

The following examples pertain to further embodiments. Example 1 includes an apparatus comprising: a work queue to store a plurality of descriptors; an arbiter to dispatch a descriptor from the work queue, wherein the descriptor comprises an operation field capable of specifying an operation to be performed, a Process Address Space Identifier (PASID) field capable of specifying a submitter PASID of a submitter process to be executed on a processor, and an Inter-Domain Permissions Table (IDPT) handle field capable of specifying an IDPT entry; and an engine to: obtain an access PASID, associated with an address space of another process, from the IDPT entry; verify, based at least in part on the submitter PASID and the IDPT entry, whether the submitter process is permitted to access the address space of the other process; and process the descriptor based at least in part on the operation specified by the operation field. Example 2 includes the apparatus of example 1, wherein the operation to be performed is one of: a copy operation, a fill operation, a compare operation, a compare pattern operation, and a flush operation. Example 3 includes the apparatus of any one of examples 1 to 2, further comprising a processor, having one or more processor cores, to execute the submitter process. Example 4 includes the apparatus of any one of examples 1 to 3, wherein a hardware accelerator comprises the work queue, the arbiter, and the engine. Example 5 includes the apparatus of any one of examples 1 to 4, wherein the hardware accelerator is to provide high-performance data movement or data transformation for data to be transmitted between a processor and a storage device. Example 6 includes the apparatus of any one of examples 1 to 5, wherein a System On Chip (SOC) device comprises the hardware accelerator and a processor. Example 7 includes the apparatus of any one of examples 1 to 6, wherein the work queue is to be configured as a Shared Work Queue (SWQ) or a Dedicated Work Queue (DWQ), wherein the SWQ is to be shared by multiple software applications and the DWQ is to be assigned to a single software application. Example 8 includes the apparatus of any one of examples 1 to 7, wherein: (a) the IDPT entry is to specify one of a single access PASID and a single submitter PASID; (b) the IDPT entry is to specify a single access PASID and a plurality of submitter PASIDs; or (c) a PASID bitmap is to specify a plurality of submitter PASIDs.

Example 9 includes an apparatus comprising: a work queue to store a plurality of descriptors; an arbiter to dispatch a descriptor from the work queue, wherein the descriptor comprises an operation field capable of specifying an operation to be performed, a Process Address Space Identifier (PASID) field capable of specifying a submitter PASID of a submitter process, an access PASID field capable of specifying an access PASID associated with the address space of another process, and an Inter-Domain Permissions Table (IDPT) handle field capable of specifying an IDPT entry; and an engine to: verify, based at least in part on the submitter PASID and the IDPT entry, whether the submitter process is permitted to access an address space of another process; and process the descriptor based at least in part on the operation specified by the operation field. Example 10 includes the apparatus of example 9, wherein the operation to be performed is one of: a copy operation, a fill operation, a compare operation, a compare pattern operation, and a flush operation. Example 11 includes the apparatus of any one of examples 9 to 10, further comprising a processor, having one or more processor cores, to execute the submitter process. Example 12 includes the apparatus of any one of examples 9 to 11, wherein a hardware accelerator comprises the work queue, the arbiter, and the engine. Example 13 includes the apparatus of any one of examples 9 to 12, wherein the hardware accelerator is to provide high-performance data movement or data transformation for data to be transmitted between a processor and a storage device. Example 14 includes the apparatus of any one of examples 9 to 13, wherein a System On Chip (SOC) device comprises the hardware accelerator and a processor. Example 15 includes the apparatus of any one of examples 9 to 14, wherein the work queue is to be configured as a Shared Work Queue (SWQ) or a Dedicated Work Queue (DWQ), wherein the SWQ is to be shared by multiple software applications and the DWQ is to be assigned to a single software application. Example 16 includes the apparatus of any one of examples 9 to 15, wherein: (a) the IDPT entry is to specify one of a single access PASID and a single submitter PASID; (b) the IDPT entry is to specify a single access PASID and a plurality of submitter PASIDs; or (c) a PASID bitmap is to specify a plurality of submitter PASIDs.

Example 17 includes a method comprising: storing a plurality of descriptors in a work queue; dispatching, at an arbiter, a descriptor from the work queue, wherein the descriptor comprises an operation field capable of specifying an operation to be performed, a Process Address Space Identifier (PASID) field capable of specifying a submitter PASID of a submitter process, and an Inter-Domain Permissions Table (IDPT) handle field capable of specifying an IDPT entry; obtaining, at an engine, an access PASID, associated with an address space of another process, from the IDPT entry; verifying at the engine, based at least in part on the submitter PASID and the IDPT entry, whether the submitter process is permitted to access the address space of the other process; and processing, at the engine, the descriptor based at least in part on the operation specified by the operation field. Example 18 includes the method of example 17, wherein the operation to be performed is one of: a copy operation, a fill operation, a compare operation, a compare pattern operation, and a flush operation. Example 19 includes the method of any one of examples 17 to 18, further comprising causing: (a) the IDPT entry to specify one of a single access PASID and a single submitter PASID; (b) the IDPT entry to specify a single access PASID and a plurality of submitter PASIDs; or (c) a PASID bitmap to specify a plurality of submitter PASIDs.

Example 20 includes a method comprising: storing a plurality of descriptors in a work queue; dispatching, at an arbiter, a descriptor from the work queue, wherein the descriptor comprises an operation field capable of specifying an operation to be performed, a Process Address Space Identifier (PASID) field capable of specifying a submitter PASID of a submitter process, an access PASID field capable of specifying an access PASID associated with the address space of another process, and an Inter-Domain Permissions Table (IDPT) handle field capable of specifying an IDPT entry; verifying at an engine, based at least in part on the submitter PASID and the IDPT entry, whether the submitter process is permitted to access an address space of another process; and processing, at the engine, the descriptor based at least in part on the operation specified by the operation field. Example 21 includes the method of example 20, wherein the operation to be performed is one of: a copy operation, a fill operation, a compare operation, a compare pattern operation, and a flush operation. Example 22 includes the method of any one of examples 20 to 21, further comprising causing: (a) the IDPT entry to specify one of a single access PASID and a single submitter PASID; (b) the IDPT entry to specify a single access PASID and a plurality of submitter PASIDs; or (c) a PASID bitmap to specify a plurality of submitter PASIDs.

Example 23 includes a computer-readable medium comprising one or more instructions that when executed on a processor configure the processor to perform one or more operations of any one of examples 17 to 22. Example 24 includes an apparatus comprising means to perform a method as set forth in any one of examples 17 to 22. Example 25 includes an apparatus comprising means to perform a method as set forth in any preceding example. Example 26.Machine-readable storage including machine-readable instructions, when executed, to implement a method or realize an apparatus as set forth in any preceding example.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

In various embodiments, one or more operations discussed with reference to FIG. 1A et seq. may be performed by one or more components (interchangeably referred to herein as "logic") discussed with reference to any of the figures.

In various embodiments, the operations discussed herein, e.g., with reference to FIG. 1A et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to "one embodiment" or "an embodiment" means that a particular feature, structure, and/or characteristic described in connection with the embodiment may be included in at least an implementation. The appearances of the phrase "in one embodiment" in various places in the specification may or may not be all referring to the same embodiment.

Also, in the description and claims, the terms "coupled" and "connected," along with their derivatives, may be used. In some embodiments, "connected" may be used to indicate that two or more elements are in direct physical or electrical contact with each other. "Coupled" may mean that two or more elements are in direct physical or electrical contact. However, "coupled" may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a work queue to store a plurality of descriptors;
an arbiter to dispatch a descriptor from the work queue, wherein the descriptor comprises an operation field capable of specifying an operation to be performed, a Process Address Space Identifier (PASID) field capable of specifying a submitter PASID of a submitter process to be executed on a processor, and an Inter-Domain Permissions Table (IDPT) handle field capable of specifying an IDPT entry; and
an engine to:
obtain an access PASID, associated with an address space of another process, from the IDPT entry;
verify, based at least in part on the submitter PASID and the IDPT entry, whether the submitter process is permitted to access the address space of the other process; and
process the descriptor based at least in part on the operation specified by the operation field.

2. The apparatus of claim 1, wherein the operation to be performed is one of: a copy operation, a fill operation, a compare operation, a compare pattern operation, and a flush operation.

3. The apparatus of claim 1, further comprising a processor, having one or more processor cores, to execute the submitter process.

4. The apparatus of claim 1, wherein a hardware accelerator comprises the work queue, the arbiter, and the engine.

5. The apparatus of claim 4, wherein the hardware accelerator is to provide high-performance data movement or data transformation for data to be transmitted between a processor and a storage device.

6. The apparatus of claim 4, wherein a System On Chip (SOC) device comprises the hardware accelerator and a processor.

7. The apparatus of claim 1, wherein the work queue is to be configured as a Shared Work Queue (SWQ) or a Dedicated Work Queue (DWQ), wherein the SWQ is to be shared by multiple software applications and the DWQ is to be assigned to a single software application.

8. The apparatus of claim 1, wherein: (a) the IDPT entry is to specify one of a single access PASID and a single submitter PASID; (b) the IDPT entry is to specify a single access PASID and a plurality of submitter PASIDs; or (c) a PASID bitmap is to specify a plurality of submitter PAS IDs.

9. An apparatus comprising:
a work queue to store a plurality of descriptors;
an arbiter to dispatch a descriptor from the work queue, wherein the descriptor comprises an operation field capable of specifying an operation to be performed, a Process Address Space Identifier (PASID) field capable of specifying a submitter PASID of a submitter process, an access PASID field capable of specifying an access PASID associated with the address space of another process, and an Inter-Domain Permissions Table (IDPT) handle field capable of specifying an IDPT entry; and
an engine to:
verify, based at least in part on the submitter PASID and the IDPT entry, whether the submitter process is permitted to access an address space of another process; and
process the descriptor based at least in part on the operation specified by the operation field.

10. The apparatus of claim 9, wherein the operation to be performed is one of: a copy operation, a fill operation, a compare operation, a compare pattern operation, and a flush operation.

11. The apparatus of claim 9, further comprising a processor, having one or more processor cores, to execute the submitter process.

12. The apparatus of claim 9, wherein a hardware accelerator comprises the work queue, the arbiter, and the engine.

13. The apparatus of claim 12, wherein the hardware accelerator is to provide high-performance data movement or data transformation for data to be transmitted between a processor and a storage device.

14. The apparatus of claim 12, wherein a System On Chip (SOC) device comprises the hardware accelerator and a processor.

15. The apparatus of claim 9, wherein the work queue is to be configured as a Shared Work Queue (SWQ) or a Dedicated Work Queue (DWQ), wherein the SWQ is to be shared by multiple software applications and the DWQ is to be assigned to a single software application.

16. The apparatus of claim 9, wherein: (a) the IDPT entry is to specify one of a single access PASID and a single submitter PASID; (b) the IDPT entry is to specify a single access PASID and a plurality of submitter PASIDs; or (c) a PASID bitmap is to specify a plurality of submitter PASIDs.

17. A method comprising:
storing a plurality of descriptors in a work queue;
dispatching, at an arbiter, a descriptor from the work queue, wherein the descriptor comprises an operation field capable of specifying an operation to be performed, a Process Address Space Identifier (PASID) field capable of specifying a submitter PASID of a submitter process, and an Inter-Domain Permissions Table (IDPT) handle field capable of specifying an IDPT entry;
obtaining, at an engine, an access PASID, associated with an address space of another process, from the IDPT entry;
verifying at the engine, based at least in part on the submitter PASID and the IDPT entry, whether the submitter process is permitted to access the address space of the other process; and
processing, at the engine, the descriptor based at least in part on the operation specified by the operation field.

18. The method of claim 17, wherein the operation to be performed is one of: a copy operation, a fill operation, a compare operation, a compare pattern operation, and a flush operation.

19. The method of claim 17, further comprising causing: (a) the IDPT entry to specify one of a single access PASID and a single submitter PASID; (b) the IDPT entry to specify a single access PASID and a plurality of submitter PAS IDs; or (c) a PASID bitmap to specify a plurality of submitter PASIDs.

20. A method comprising:
storing a plurality of descriptors in a work queue;
dispatching, at an arbiter, a descriptor from the work queue, wherein the descriptor comprises an operation field capable of specifying an operation to be performed, a Process Address Space Identifier (PASID) field capable of specifying a submitter PASID of a submitter process, an access PASID field capable of specifying an access PASID associated with the address space of another process, and an Inter-Domain Permissions Table (IDPT) handle field capable of specifying an IDPT entry;
verifying at an engine, based at least in part on the submitter PASID and the IDPT entry, whether the submitter process is permitted to access an address space of another process; and
processing, at the engine, the descriptor based at least in part on the operation specified by the operation field.

21. The method of claim 20, wherein the operation to be performed is one of: a copy operation, a fill operation, a compare operation, a compare pattern operation, and a flush operation.

22. The method of claim 20, further comprising causing: (a) the IDPT entry to specify one of a single access PASID and a single submitter PASID; (b) the IDPT entry to specify a single access PASID and a plurality of submitter PASIDs; or (c) a PASID bitmap to specify a plurality of submitter PASIDs.

23. One or more non-transitory computer-readable media comprising one or more instructions that when executed on a processor configure the processor to perform one or more operations to:
store a plurality of descriptors in a work queue;
dispatch, at an arbiter, a descriptor from the work queue, wherein the descriptor comprises an operation field capable of specifying an operation to be performed, a Process Address Space Identifier (PASID) field capable of specifying a submitter PASID of a submitter process, and an Inter-Domain Permissions Table (IDPT) handle field capable of specifying an IDPT entry;
for a restricted inter-domain memory operation descriptor:
obtain, at an engine, an access PASID, associated with an address space of another process, from the IDPT entry;
verify at the engine, based at least in part on the submitter PASID and the IDPT entry, whether the submitter process is permitted to access the address space of the other process; and
process, at the engine, the descriptor based at least in part on the operation specified by the operation field; and
for an unrestricted inter-domain memory operation descriptor:
verify at the engine, based at least in part on the submitter PASID and the IDPT entry, whether the submitter process is permitted to access an address space of another process; and
process, at the engine, the descriptor based at least in part on the operation specified by the operation field.

24. The one or more computer-readable media of claim 23, wherein the operation to be performed is one of: a copy operation, a fill operation, a compare operation, a compare pattern operation, and a flush operation.

25. The one or more computer-readable media of claim 23, further comprising one or more instructions that when executed on the processor configure the processor to perform one or more operations to cause: (a) the IDPT entry to specify one of a single access PASID and a single submitter PASID; (b) the IDPT entry to specify a single access PASID and a plurality of submitter PASIDs; or (c) a PASID bitmap to specify a plurality of submitter PASIDs.
